(19) United States
(12) Patent Application Publication
(10) Pub. No.: US 2013/0333973 A1
(43) Pub. Date: Dec. 19, 2013

(54) SAFETY VALVE APPARATUS FOR PREVENTING DISPERSAL OF TRANSPORTABLE MATTER

(71) Applicant: David Cormack, Brampton (CA)

(72) Inventor: David Cormack, Brampton (CA)

(21) Appl. No.: 13/745,460

(22) Filed: Jan. 18, 2013

Related U.S. Application Data
(60) Provisional application No. 61/660,229, filed on Jun. 15, 2012.

(51) Int. Cl. B66F 9/075

(52) U.S. Cl. CPC B66F 9/07572
USPC 180/301; 137/15.17

(57) ABSTRACT

An embodiment of the present invention relates to a valve apparatus that is designed to help protect users of liquefied propane gas (“LPG”) powered equipment from being injured while using, connecting, or disconnecting a coupler that connects an LPG supply line to an LPG container. The valve apparatus may, for example, prevent LPG from escaping into the environment while the supply line is being, or after it has been, disconnected.

### CROSS-REFERENCE TO RELATED APPLICATIONS

This application claims the benefit of provisional patent application Ser. No. 61/660,229, filed Jun. 15, 2012 by the present inventor.

### FIELD

The described embodiments relate to Liquid Petroleum Gas (“LPG”) supply in forklift trucks.

### Introduction

Liquids, gases or liquefied gases are used to power many types of equipment. LPG is a common liquefied gas used to power equipment such as, for example, forklifts, scrubbers, sweepers, aerial lifts, and skid steers. When used to power such equipment, LPG can be stored in, for example, a cylindrical container, where the liquefied gas can be supplied to the equipment through a supply connected to the container by a detachable coupler.

### SUMMARY

One aspect of the present invention addresses safety concerns when replacing LPG containers by providing a safety valve on the supply line or the container to significantly reduce the amount of LPG gas that can escape from the supply line or the container when an operator is removing or replacing an LPG container.

Further, in another aspect the present invention can decrease the time required to remove or replace an LPG container since it can no longer be necessary to “bleed” the supply line by running the engine prior to disconnecting the container. This can also provide the benefit of allowing the user to save fuel since the fuel that would have been bled can now be used to do productive work.

In another aspect of the present invention, a handle on the safety valve, on the supply line, the container, or both, is designed in such a way that the handle inhibits removing or replacing the container unless the safety valve is in a position that will reduce the amount of LPG gas that can escape from the supply line or the container when an operator is removing or replacing an LPG container. This addresses the problem of the operator forgetting, or otherwise omitting, to move the safety valve to the proper position before removing or replacing the LPG container.

In accordance with an aspect of an embodiment of the present invention, there is provided a forklift truck comprising a truck frame for supporting a liquid petroleum gas (LPG) container; an engine for powering the forklift truck, the engine being configured to run on LPG; and a LPG supply system having a supply conduit for supplying LPG from the LPG container to the engine, a coupler for coupling to the LPG container, and a shut-off valve installed in fluid communication with the supply conduit downstream from the coupler.

The shut-off valve has a coupler end proximal the coupler and a conduit end proximal the supply conduit. The shut-off valve also has a closed position and an open position wherein in the open position the shut-off valve provides a fluid flow pathway of the fluid from the coupler end to the conduit end, and in the closed position the shut-off valve blocks flow of the LPG from the conduit end to the coupler end.

In accordance with an aspect of another embodiment of the present invention, there is provided a method for modifying a forklift truck having a truck frame for supporting a liquid petroleum gas (LPG) container; an engine for powering the forklift, the engine being configured to run on LPG; a supply conduit for supplying LPG from the LPG container to the engine; and a coupler, having a first end configured for attachment to an upstream end of the supply conduit, to connect the supply conduit to the LPG container. The method comprises attaching a safety valve apparatus to the upstream end of the supply conduit, the safety valve apparatus having an upstream opening, a downstream opening, and a shut-off valve connected between the upstream opening and the downstream opening. The shut-off valve has an upstream end proximal the upstream opening and a downstream end proximal the downstream opening. The shut-off valve also has a closed position and an open position wherein in the open position the shut-off valve provides a fluid flow pathway of the fluid from the upstream end of the shut-off valve to the downstream end, and in the closed position the shut-off valve blocks flow of the fluid from the downstream end to the upstream end of the shut-off valve.

Other aspects and features of the teachings disclosed herein will become apparent, to those ordinarily skilled in the art, upon review of the following description of the specific examples of the present invention.

### DRAWINGS

Embodiments of the present invention will now be discussed in detail with reference to the drawings, in which:

FIG. 1 is a perspective view of a forklift truck showing one embodiment of the safety valve apparatus and includes a magnified view of part of the forklift truck.

FIG. 2A is a side view of one embodiment of the safety valve apparatus, showing the safety valve in an open position.

FIG. 2B is a top view of the embodiment of FIG. 2A, showing the safety valve in an open position.

FIG. 2C is a side view of the embodiment of FIG. 2A, showing the safety valve in a closed position.

FIG. 3A is a top view of another embodiment of the safety valve apparatus showing the safety valve in an open position.

FIG. 3B is a side view of the embodiment of FIG. 3A, showing the safety valve in a closed position.

FIGS. 4A to 4D, in side views of an example safety valve apparatus and a fluid supply system, show steps in retrofitting the existing fluid supply system with one embodiment of the safety valve apparatus.

FIGS. 5A and 5B, in side views of another example safety valve apparatus and a fluid supply system, show steps in retrofitting the existing fluid supply system with another embodiment of the safety valve apparatus.

FIGS. 6A to 6D, in side views of yet another example safety valve apparatus and a fluid supply system, show steps in retrofitting the existing fluid supply system with yet another embodiment of the safety valve apparatus.

### DESCRIPTION OF VARIOUS EMBODIMENTS

Although the specification refers to safety issues, a person skilled in the art would appreciate that the described embodiments can be adapted to any application that can require restricting the dispersal of transportable matter. Further, although the specification refers mainly to LPG as the transportable matter, a person skilled in the art will appreciate that the described embodiments can be adapted for use with containers and supply lines that can adequately house and supply any transportable matter, such as, for example, liquids, gases, solid particles, slurries, other liquefied-gases, etc.

There exist safety concerns related to replacing such LPG containers. When an LPG container used to supply fuel to equipment is empty, or nearly empty, an operator will exchange the old container for a new container. The correct procedure to exchange an

LPG container is to turn off the supply valve on the container while the engine of the equipment continues to operate; this burns off the fuel still under pressure in the supply line (the length of which could be, for example, from 12″ to 30″) that connects the container to the engine. Once the equipment ceases operating due to lack of fuel, there should generally be no pressure in the supply line, and it becomes safe to detach the coupler that connects the supply line to the container. The entire procedure generally takes from 2 to 5 minutes to complete.

Because many operators want to replace LPG containers more quickly, they can not follow the correct procedure. If the operator does not follow correct procedure, it can result in LPG escaping from a disconnected supply line due to, for example, pressure in the supply line. The escaping LPG can be at a very low temperature (−44 degree F., for example); if it comes in contact with the operator's hand, or other vulnerable area, it can cause a serious frost burn. Such burns can result in skin problems, such as nerve damage and skin irritation, and in more serious instances, can require the operator to obtain skin grafts.

Further, the LPG containers of LPG powered forklifts are often replaced before the fuel in the container runs out. Since operators of the forklift can be working a fair distance from a propane exchange area, they can choose to exchange the propane container at a time when there is still fuel in the container; this can ensure that they do not have to carry additional LPG containers over long distances. If during exchange, the O-ring in the coupler fails while the supply lines still contains fuel, pressurized fuel in the supply lines can escape, potentially injuring the operator.

Further, while installing a new container, the container's shut-off valve should always be checked to ensure it is closed; however, as often happens, the valve can not be checked, and if the O-ring is not sealed properly, it can result in LPG being released onto the operator's hand.

Further, implementing policies that require the operator to wear safety gear often proves ineffective in practice. For example, to prevent the LPG from contacting an operator's skin, the MSDS requires that when the operator is working with LPG, the operator should wear safety goggles for eye protection and specialized gloves for hand and arm protection. The gloves are generally made of PVC or neoprene. Although such safety gear can offer adequate protection if LPG escapes from the container's coupler area, there are many cases where the operator is not wearing appropriate safety gloves or goggles. For example, in many cases the proper gloves cannot be located, which can result in the operator exchanging an LPG container without the proper safety gear, or with safety gear that is not suitable for replacing LPG containers.

Operators can not always follow the recommended process of replacing or removing LPG containers, and even if they do, there can still be situations where LPG escapes from the supply line or the container, injuring the operator.

Generally speaking, the safety valve apparatus of the various exemplary embodiments described herein can be used to increase safety or efficiency of processes that involve the detachment of a supply line from a container, for example, exchanging a LPG container on a forklift truck.

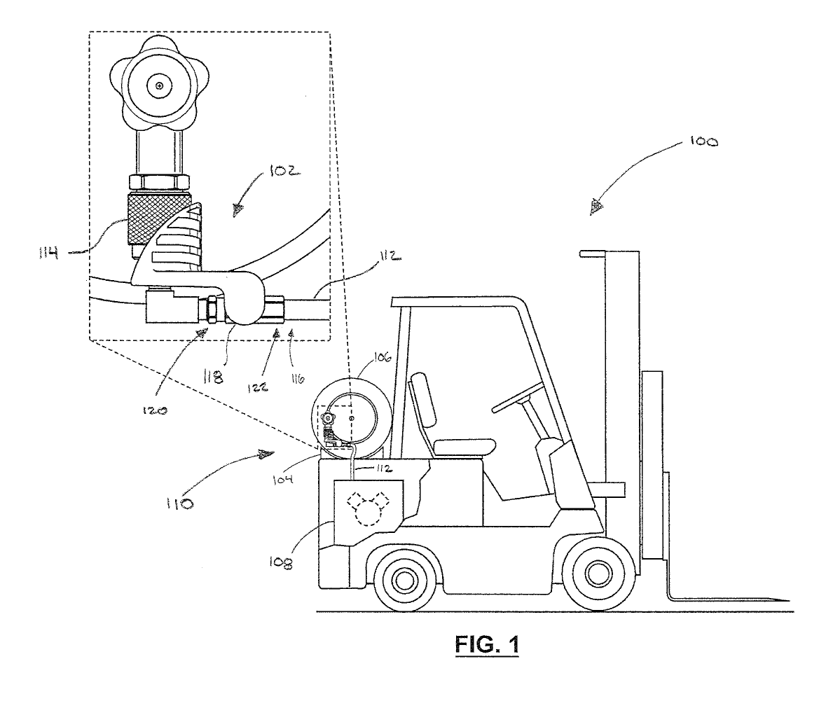

Reference is made to FIG. 1, which illustrates a perspective view of a forklift truck 100 incorporating one embodiment of the safety valve apparatus 102. It should be appreciated that forklift truck 100 is a simplified view of one embodiment of the present invention and can include additional elements that are not depicted. As shown, in some embodiments, the forklift truck 100 can include a truck frame 104 for supporting a LPG container 106, an engine 108 for powering the forklift truck 100, and a LPG supply system 110. The engine 108 can be configured to run on LPG. The LPG supply system 110 can have a supply conduit 112 for supplying LPG from the LPG container 106 to the engine 108, a coupler 114 for coupling an upstream end 116 of the supply conduit 112 to the LPG container 106, and a shut-off valve 118. The shut-off valve 118 can be installed in fluid communication with the supply conduit 112 downstream from the coupler 114. The shut-off valve 118 can have a coupler end 120 proximal the coupler 114 and a conduit end 122 proximal the supply conduit 112. The shut-off valve 118 can have a closed position and an open position wherein in the open position the shut-off valve 118 can provide a fluid flow pathway of the fluid from the coupler end 120 to the conduit end 122, and in the closed position the shut-off valve 118 can block flow of the LPG from the conduit end 122 to the coupler end 120.

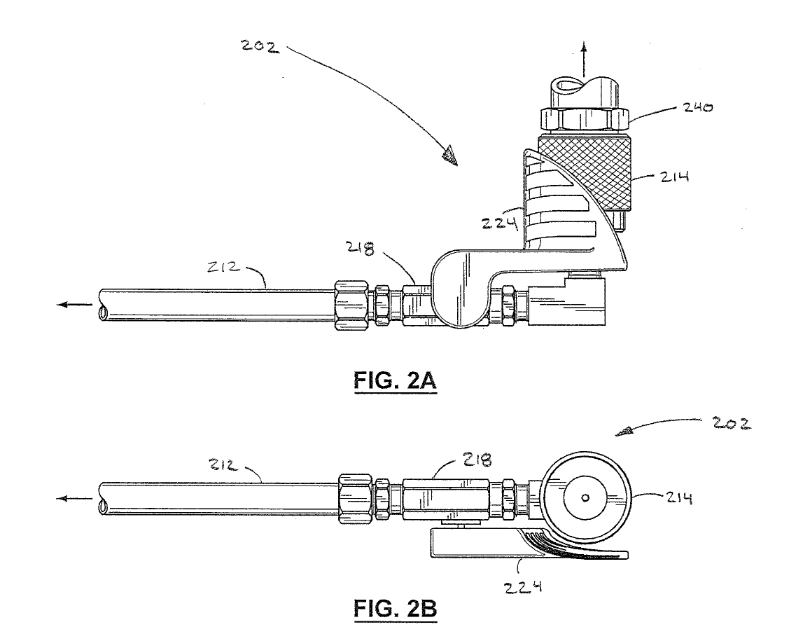

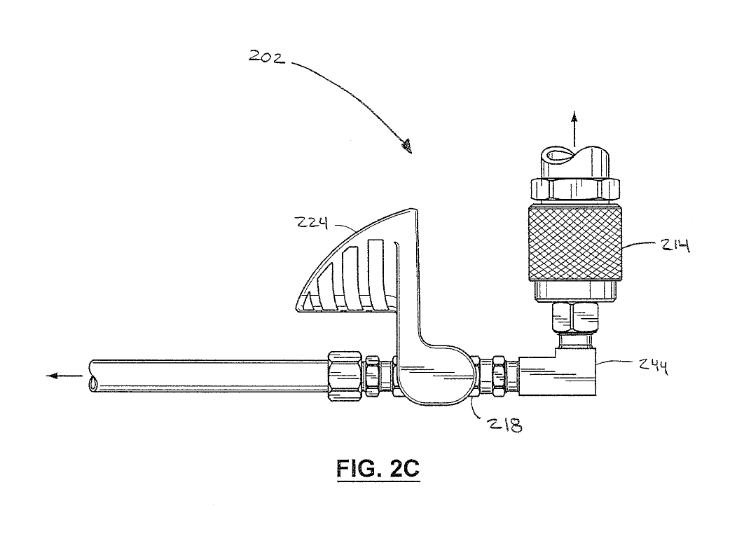

Reference is now made to FIGS. 2A and 2B, which illustrates a detailed side view (FIG. 2A) and top view (FIG. 2B) of one embodiment of the safety valve apparatus 202, showing the shut-off valve 218 in an open position. It should be appreciated that the safety valve apparatus 202 can include additional elements that are not depicted and that similar reference numerals, differing by 100, are used for common elements between the embodiment disclosed in FIGS. 2A and 2B and the embodiment disclosed in FIG. 1. In this embodiment, the LPG container 206 (not shown) can supply LPG through a supply nozzle 240 controlled by an LPG container valve 242 (not shown). A supply conduit 212 can be connected to the supply nozzle 240 through a coupler 214. In some embodiments, the coupler 214 can contain a threaded interior that allows threaded attachment to a threaded exterior of the supply nozzle 240; in such an embodiment, an operator can connect the coupler 214 to the supply nozzle 240 or disconnect the coupler 214 from the supply nozzle 240 by, for example, turning the coupler 214 counter-clockwise or clockwise, as indicated by the threading direction. In another embodiment the coupler 214 can be disconnectable by a portion of a surface of the coupler being moved, for example by an operator pushing a button on the coupler that causes the coupler to decouple or by an operator sliding a portion of the coupler.

In the embodiment shown in FIGS. 2A and 2B, a shut-off valve 218 can be connected between the coupler 214 and the supply conduit 212. The shut-off valve 218 can be positioned very close to the coupler 214. In some embodiments the shut-off valve can be positioned immediately downstream of the coupler 214. In other embodiments the internal volume of an interior volume provided between the shut-off valve 218 in the closed position and the coupler 214 can be less than 2 milliliters (mL), to limit an amount of LPG containable within the internal volume of an interior volume provided between the shut-off valve 218 in the closed position and the coupler 214. In other embodiments, the internal volume in the interior volume between the shut-off valve 218 in the closed position and the coupler 214 can be less than 1.1 milliliters or 0.8 milliliters. The shut-off valve 218 can be any type of valve that can be used in conjunction with the transportable matter within the container, which in one embodiment can be LPG. Some examples of suitable valves include ball valves, check valves or one-way valves, gate valves, globe valves, butterfly valves, stem valves, control valves or any other valve that can prevent the supplied transportable matter from passing between the supply conduit 212 and the coupler 214, and which has the necessary safety ratings to do so. In a further embodiment, the shut-off valve 218 can be a one-way valve that allows fluid to flow from a first end of the shut-off valve 218 proximal the coupler 214 to a second end of the shut-off valve 218 proximal the supply conduit 212 by moving to an open position, and can impede or block fluid flow from the second end to the first end by moving to a closed position. In a further embodiment the one-way valve can automatically (i.e. without operator interaction) move to the open position when the pressure of the fluid at the first end of the shut-off valve 218 is greater than the pressure of the fluid at the second end of the shut-off valve 218, and can automatically move to the closed position when the pressure of the fluid at the second end of the shut-off valve 218 is greater than the pressure of the fluid at the first end of the shut-off valve 218.

In the embodiment shown in FIGS. 2A and 2B, the shut-off valve 218 can comprise an external arm 224 that can be a valve handle, which can be moved by an operator to open or close the shut-off valve 218. The external arm 224 can be movable between an open arm position and a closed arm position. The external arm 224 can be connected to the shut-off valve 218 such that when the shut-off valve 218 is in the closed position the external arm 224 is in the closed arm position and does not impede decoupling the coupler 214. The shut-off valve 218 and the external arm 224 can be designed and positioned relative to one another in such a way that the external arm 224 can open the shut-off valve 218 only when the external arm 224 is in an open arm position that impedes or makes it difficult for an operator to decouple the coupler 214 (see, for example, FIGS. 2A and 2B). In a further embodiment, the external arm 224 in the open arm position may abut the coupler 214 to impede decoupling of the coupler 214. The coupler 214 can have an external surface and be decouplable by the external surface being gripped and rotated. The external arm 224 can be designed and positioned relative to the coupler so that when the shut-off valve 218 is in an open position, the external arm 224 abuts, surrounds or borders a portion of the coupler 214 and impedes or makes it difficult for an operator to grip, or turn, the coupler 214. In another embodiment, the coupler 214 can have an external surface and be decouplable by the external surface being gripped and rotated through a path of rotation. The external arm 224 in the open arm position can protrude into the path of rotation to interfere with rotation of the external surface of the coupler 214 by blocking the path of rotation. In another embodiment, the external arm 224 can be designed and positioned relative to the coupler to make it difficult for an operator to press a button on the coupler to decouple the coupler when the shut-off valve 218 is in the open position. In another embodiment, the external arm 224 can be designed and positioned relative to the coupler to make it difficult for an operator to slide a portion of the coupler to decouple the coupler when the shut-off valve 218 is in the open position. In another embodiment, the external arm 224 can be designed and positioned relative to the coupler to make it difficult for an operator to move a portion of the coupler to decouple the coupler when the shut-off valve 218 is in the open position.

Reference is now made to FIG. 2C, which illustrates a close up side view of the embodiment of FIGS. 2A and 2B of the safety valve apparatus 202, but showing the shut-off valve 218 in a closed position. In this embodiment, the shut-off valve 218 and the external arm 224 can be designed and positioned relative to one another in such a way that the external arm 224 can close the shut-off valve 218 when the external arm 224 is in a position that allows an operator to access the coupler 214. The external arm 224 can be designed so that it closes the shut-off valve 218 whenever the external arm 224 is in a position that allows an operator to grip, or turn, the coupler 214 to decouple the coupler 214 without difficulty. In another embodiment, the external arm 224 can be designed and positioned relative to the coupler 214 so that it closes the shut-off valve 218 whenever the external arm 224 is in a position that allows an operator to press a button on the coupler 214 to decouple the coupler 214 without difficulty. In another embodiment, the external arm 224 can be designed and positioned relative to the coupler 214 so that it closes the shut-off valve 218 whenever the external arm 224 is in a position that allows an operator to slide a portion of the coupler 214 to decouple the coupler 214 without difficulty. In another embodiment, the external arm 224 can be designed and positioned relative to the coupler 214 so that it closes the shut-off valve 218 whenever the external arm 224 is in a position that allows an operator to move a portion of the coupler 214 to decouple the coupler 214 without difficulty.

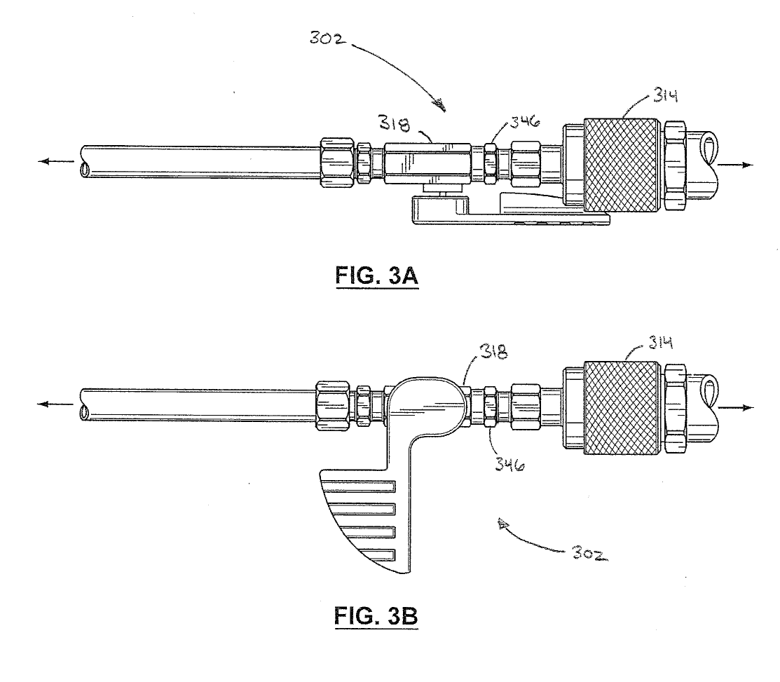

In the embodiment of FIGS. 2A, 2B and 2C, there can be an elbow 244 located between the shut-off valve 218 and the coupler 214. In this embodiment, the elbow 244 can be a 90 degree elbow. In a further embodiment, the elbow 244 can be of a degree other than 90 degrees, for example the elbow 244 can be a 45 degree elbow. In yet a further embodiment, the shut-off valve 218 can connect directly to the coupler 214 without incorporating the elbow 244; such an embodiment is described in greater detail below, in reference to FIGS. 3A and 3B.

Reference is now made to FIGS. 3A and 3B, which illustrate a detailed top view (FIG. 3A) and side view (FIG. 3B) of a further embodiment of a safety valve apparatus 302, showing a shut-off valve 318 in the open position (FIG. 3A) and the closed position (FIG. 3B). It should be appreciated that the safety valve apparatus 302 illustrated in FIGS. 3A and 3B is a simplified view of another embodiment of the safety valve apparatus 202 illustrated in FIGS. 2A, 2B and 2C and can include additional elements that are not depicted. Correspondingly, similar reference numerals, differing by 100, are used for common elements between the embodiment disclosed in FIGS. 2A, 2B and 2C and the embodiment disclosed in FIGS. 3A and 3B. The safety valve apparatus 302 illustrated in FIGS. 3A and 3B is similar to the safety valve apparatus 202 illustrated in FIGS. 2A, 2B and 2C. For example, the connection to the supply conduit and the shut-off valve are similar. However, the external arm 324 embodied in FIGS. 3A and 3B differs from the external arm 224 embodied in FIGS. 2A, 2B and 2C and the connection between the shut-off valve and the coupler also differs between FIGS. 3A and 3B and FIGS. 2A, 2B and 2C.

In the embodiment of FIGS. 3A and 3B, the shut-off valve 318 can be directly connected to the coupler 314 without the use of an elbow. In this embodiment, the longitudinal axis of the coupler 314 can be in-line, or substantially in-line, with the longitudinal axis of the shut-off valve 318. In a further embodiment, a coupling 346 can be included between the shut-off valve 318 and the coupler 314. The coupling 346 can be a threaded coupling with two male ends, in some embodiments. Alternatively, coupling 346 can be a threaded coupling with two female ends, or with one male and one female ends. In some embodiments the coupling 346 may be integral with the shut-off valve 318. A person skilled in the art will appreciate the shut-off valve 318 can be connected to the coupler 314 through a variety of connection methods known in the art in accordance with different embodiments of the present invention.

Referring again to FIGS. 2A, 2B and 2C, when an operator wants to remove or exchange the existing LPG container 206 from a piece of equipment, such as the forklift truck 200, the operator first closes the shut-off valve 218 on the container and can then disconnect the coupler 214 from the LPG container 206. Disconnecting the coupler 214 from the existing LPG container 206 is facilitated by the operator being able to access the coupler 214 without significant difficulty.

In this embodiment, to access the coupler 214 without difficulty, the operator can rotate external arm 224 away from the coupler 214 by, for example, turning external arm 224 by 90 degrees; such a rotation of the external arm 224 can cause shut-off valve 218 to close, resulting in a sealed supply conduit 212. Since the operator can now access the coupler 214 with less difficulty, he can disconnect it from the LPG container 206.

When the coupler 214 is disconnected from the LPG container 206, the shut-off valve 218 can remain in a closed position to thereby reduce the amount of LPG that can escape from the supply conduit 212. Some residual LPG can remain in the fitting of the coupler 214, but if the shut-off valve 218 is installed close to, or against, the coupler 214, the amount can be kept to a minimum to reduce the risk of injury to the operator. In a further embodiment, the shut-off valve 218 can include a lock 252, which can impede the shut-off valve 218 from moving from the closed position to another position, which can be the open position. This lock 252 can help the operator to avoid accidentally opening the shut-off valve 218 while the LPG container 206 is being removed or replaced. In some embodiments the lock 252 can comprise interlocking external protrusions, a padlock, a combination lock, a pin, or various other methods for preventing movement of a valve known in the art in accordance with different embodiments of the present invention. In a further embodiment the lock 252 can impede the external arm 224 from moving and thereby impede the shut-off valve 218 from moving because of the connection between the external arm 224 and the shut-off valve 218.

The operator can choose to connect the coupler 214 to a replacement LPG container. Once the coupler 214 is connected to the replacement LPG container, shut-off valve 218 can still be in a closed position, restricting LPG flow from the replacement LPG container to supply conduit 212. To allow LPG to flow from the replacement LPG container to supply conduit 212, the operator can open shut-off valve 218. The operator can open shut-off valve 218 by rotating the external arm 224 back to its original (open) position. Rotating the external arm 224 back to its original position opens shut-off valve 218, allowing LPG to flow from the replacement LPG container to supply conduit 212, but results in the external arm 224 again restricting access to the coupler 214; this increases the likelihood that an operator will once again close shut-off valve 218 before disconnecting the coupler 214 from the replacement LPG container.

In a further embodiment, the shut-off valve 218 and the external arm 224 can be designed in such a way that the external arm 224 can open the shut-off valve 218 only when the external arm 224 is in a position that prevents the coupler 214 from disconnecting from the LPG container 206.

In a further embodiment, the coupler 214 can have an external surface, and the coupler 214 can be decoupled by the external surface being moved, the external arm 224 can have a high friction coating, and the high friction coating can be configured to interact with the external surface to impede movement of the external surface when the external arm 224 is in the open arm position. In a further embodiment, the coupler 214 can be a quick-connect type coupler (or quick coupling), as will be apparent to a person skilled in the art. In some embodiments, the quick coupling can be designed to decouple by the operator gripping and sliding a portion of the coupler 214. In some embodiments, the quick coupling can be designed to decouple by the operator gripping a portion of the coupler and by turning and sliding said portion. In some embodiments, the quick coupling can be designed to couple with a nipple attached to the LPG container 206. In some embodiments, the quick coupling can couple with the nipple by the operator pushing the quick coupling and the nipple together. In different embodiments, the quick coupling can be designed to connect to the LPG container 206 in a variety of connection methods known in the art in accordance with different embodiments of the present invention. In another embodiment, the external arm 224 and the coupler 214 can be designed to comprise interlocking portions, wherein if the external arm 224 is in an open position, the external arm 224 interlocks with the coupler 214, preventing the coupler 214 from moving or rotating. In one embodiment, the interlocking portions can comprise complimentary threaded surfaces of the coupler 214 and the external arm 224, wherein when the external arm 224 is in the open position the threaded surfaces can interlock, substantially limiting the movement or rotation of the coupler 214. In another embodiment, the interlocking portions can comprise complimentary interference keys located on the coupler 214 and the external arm 224, wherein when the external arm 224 is in the open position, the interference keys can come into contact, substantially limiting the movement or rotation of the coupler 214. In some embodiments, the interlocking portions can be a variety of interlocking methods known in the art in accordance with different embodiments of the present invention.

In a further embodiment, the external arm 224 and the coupler 214 can include external protrusions that can be configured to interlock to impede decoupling the coupler 214 when the external arm 224 is in the open arm position. In a further embodiment, the external protrusions can include a first threaded surface on the external arm 224 and a second threaded surface on the coupler 214, and the first threaded surface and the second threaded surface can be configured to interlock when the external arm 224 is in the open arm position. In a further embodiment, the external protrusions can include a first interference key on the external arm 224 and a second interference key on the coupler 214, the first interference key and the second interference key can be configured to interlock when the external arm 224 is in the open arm position.

In yet a further embodiment, an LPG container can include an LPG container valve external arm similar to the external arms 224 or 324, which can be used to control the existing LPG container valve, or an additional valve on or attached to the LPG container. The LPG container valve and the LPG container valve external arm can be designed and positioned relative to a coupler, connecting the LPG container to a supply conduit, in such a way that the LPG container valve external arm can open the LPG container valve only when the LPG container valve external arm is in a position that makes it difficult for an operator to access or disconnect the coupler used to connect the supply conduit to the LPG container, similar to designs and positions described above. In a further embodiment, the LPG container valve external arm can be provided in addition to the safety valve apparatus on the supply conduit previous described herein, or in addition to other embodiments of safety valve apparatus described herein.

Further aspects of a further embodiment of the present invention can include retrofitting a forklift truck, which can have a truck frame for supporting a LPG container, an engine for powering the forklift, the engine being configured to run on LPG, a supply conduit for supplying LPG from the LPG container to the engine, and a coupler to connect the supply conduit to the LPG container. The coupler can have a first end configured for attachment to an upstream end of the supply conduit. Retrofitting can include attaching a safety valve apparatus to the upstream end of the supply conduit, the safety valve apparatus can have an upstream opening, a downstream opening, and a shut-off valve connected between the upstream opening and the downstream opening. The shut-off valve can have an upstream end proximal the upstream opening and a downstream end proximal the downstream opening. The shut-off valve can have a closed position and an open position, wherein in the open position the shut-off valve can provide a fluid flow pathway of the fluid from the upstream end of the shut-off valve to the downstream end, and in a closed position the shut-off valve can block flow of the fluid from the downstream end to the upstream end of the shut-off valve. In some embodiments, the safety valve apparatus can be similar to the safety valve apparatus 202 shown in FIGS. 2A, 2B and 2C or the safety valve apparatus 302 shown in FIGS. 3A and 3B. In other embodiments, the safety valve apparatus can be any of the safety valve apparatus embodiments described herein.

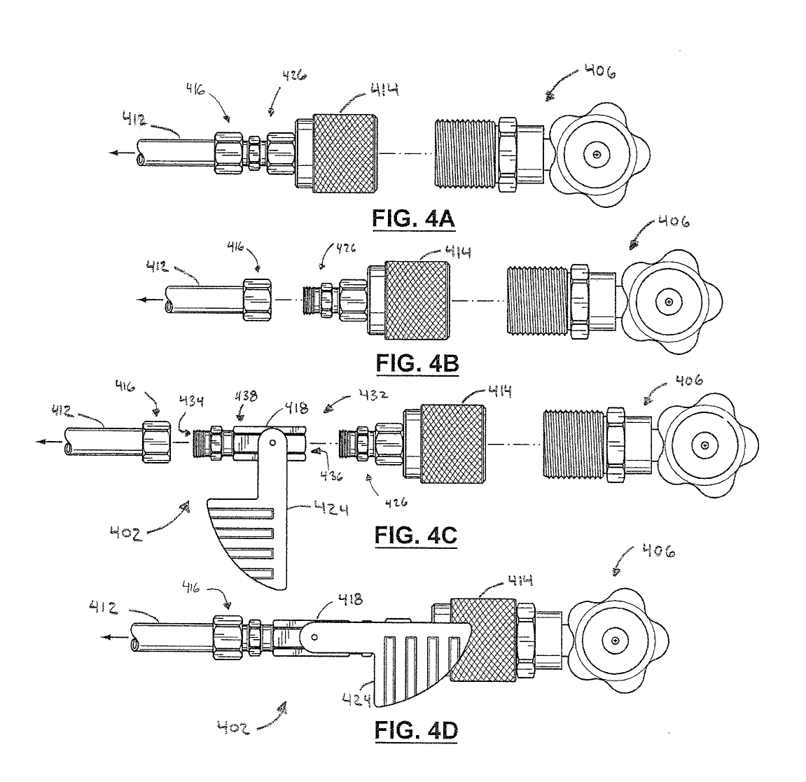

Reference is now made to FIGS. 4A to 4D. In yet a further embodiment, the safety valve apparatus 402 can be designed so that an existing supply conduit 412 comprising a coupler 414 can be retrofitted by attaching the safety valve apparatus 402 to an upstream end 416 of the supply conduit 412. For simplicity, the following paragraphs use reference numerals similar, differing by 100, to the reference numerals of the safety valve apparatus shown in FIGS. 3A and 3B, namely safety valve apparatus 302. However, a person skilled in the art will appreciate that these aspect of the present invention are not limited to retrofitting using safety valve apparatus 302 only and can include retrofitting using any of the embodiments for the safety valve apparatus described herein.

In some embodiments, retrofitting the existing supply conduit 412 by attaching the safety valve apparatus 402 to the upstream end 416 of the supply conduit 412 can comprise disconnecting a first end 426 of the coupler 414 from the upstream end 416 of the supply conduit 412 (as shown in FIG. 4B) and attaching the safety valve apparatus 402 to both the upstream end 416 of the supply conduit 412 and the first end 426 of the coupler 414 (as shown in FIGS. 4C and 4D). The safety valve apparatus 402 can have an upstream opening 432 and a downstream opening 434. The safety valve apparatus 402 can comprise a shut-off valve 418. The shut-off valve 418 can be connected between the upstream opening 432 and the downstream opening 434. The shut-off valve 418 can have the upstream end 436 proximal the upstream opening 432 and the downstream end 438 proximal the downstream opening 434. The shut-off valve 418 can have a closed position and an open position. The shut-off valve 418 can provide a fluid flow pathway for the LPG from the upstream end 436 of the shutoff valve 418 to the downstream end 438, when the shut-off valve 418 is in the open positions, and can block flow of the LPG from the downstream end 438 to the upstream end 436 of the shut-off valve 418, when the shut-off valve 418 is in the closed position. The upstream end 416 of the supply conduit 412 can be attached to the downstream opening 434 of the safety valve apparatus 402 and the first end 426 of the coupler 414 can be attached to the upstream opening 432 of the safety valve apparatus 402. The coupler 414 can thereby provide a connection configured to connect the supply conduit 412 to the LPG container 406 (shown in part in FIGS. 4A to 4D)

In one embodiment the upstream end 416 of the supply conduit 412 and the first end 426 of the coupler 414 can be attached to the safety valve apparatus 402 by threaded attachment. In other embodiments the upstream end 416 of the supply conduit 412 and the first end 426 of the coupler 414 can be attached to the safety valve apparatus 402 by press fit, welding, or bonding. In other embodiments the upstream end 416 of the supply conduit 412 and the first end 426 of the coupler 414 can be attached to the safety valve apparatus 402 through a variety of attachment methods known in the art in accordance with different embodiments of the present invention.

In a further embodiment, the shut-off valve 418 can be located immediately downstream from the upstream opening 432 when the safety valve apparatus 402 is attached to the upstream end 416 of the supply conduit 412.

In a further embodiment, the shut-off valve 418 can be located immediately downstream from the connection between the coupler 414 and the LPG container 406 when the safety valve apparatus 402 is attached to the upstream end 416 of the supply conduit 412.

In a further embodiment, an internal volume of the coupler 414 and the safety valve apparatus 402 between the connection to the LPG container 406 and the shut-off valve 418 can be less than 2 milliliters, to limit the amount of LPG containable with the internal volume of the coupler 414 and the safety valve apparatus 402 between the connection to the LPG container 406 and the shut-off valve 418. In other embodiments, the internal volume of the coupler 414 and the safety valve apparatus 402 between the connection to the LPG container 406 and the shut-off valve 418 can be less than 1.1 milliliters or 0.8 milliliters.

In a further embodiment, the shut-off valve 418 can also comprise an external arm 424. The external arm 424 can be oriented in a manner similar to those mentioned previously that allows the external arm 424 to impede access to, or detachment of, the coupler 414. The external arm 424 can be movable by an operator to switch the shut-off valve 418 between the open position and the closed position. The external arm 424 can be connected to the shut-off valve 418 such that when the shut-off valve 418 is in the closed position, the external arm 424 is in a closed arm position, and when the shut-off valve 418 is in the open position, the external arm 424 is in an open arm position. The external arm 424 can be moveable between the open arm position and the closed arm position. Attaching the safety valve apparatus 402 to the upstream end 416 of the supply conduit 412 can comprise orienting the external arm 424 relative to the coupler 414 such that the external arm 424 in the closed arm position does not impede disconnecting the coupler 414 from the LPG container 406, while the external arm 424 in the open arm position does impede disconnecting the coupler 414 from the LPG container 406.

In a further embodiment, orienting the external arm 424 relative to the coupler 414 can comprise orienting the external arm 424 such that the external arm 424 in the open arm position abuts the coupler 414 to impede disconnecting the coupler 414 from the LPG container 406.

In a further embodiment, the coupler 414 can have an external surface and can be disconnectable from the LPG container 406 by the external surface being gripped and rotated. Orienting the external arm 424 relative to the coupler 414 can comprise orienting the external arm 424 such that the external arm 424 in the open arm position abuts and impedes gripping of a substantial portion of the external surface of the coupler 414.

In a further embodiment, the coupler 414 can have an external surface and can be disconnectable from the LPG container 406 by the external surface being gripped and rotated through a path of rotation. Orienting the external arm 424 relative to the coupler 414 can comprise orienting the external arm 424 such that the external arm 424 in the open arm position protrudes into the path of rotation of the external surface of the coupler 414 to interfere with rotation of the external surface of the coupler 414 through the path of rotation.

In a further embodiment, the shut-off valve 418 can be a one-way valve configured to provide one-way fluid flow by moving to the open position to provide LPG flow from the upstream end 436 of the shut-off valve 418 to the downstream end 438 and by moving to the closed position to block LPG flow from downstream end 438 to the upstream end 436 of the shut-off valve 418.

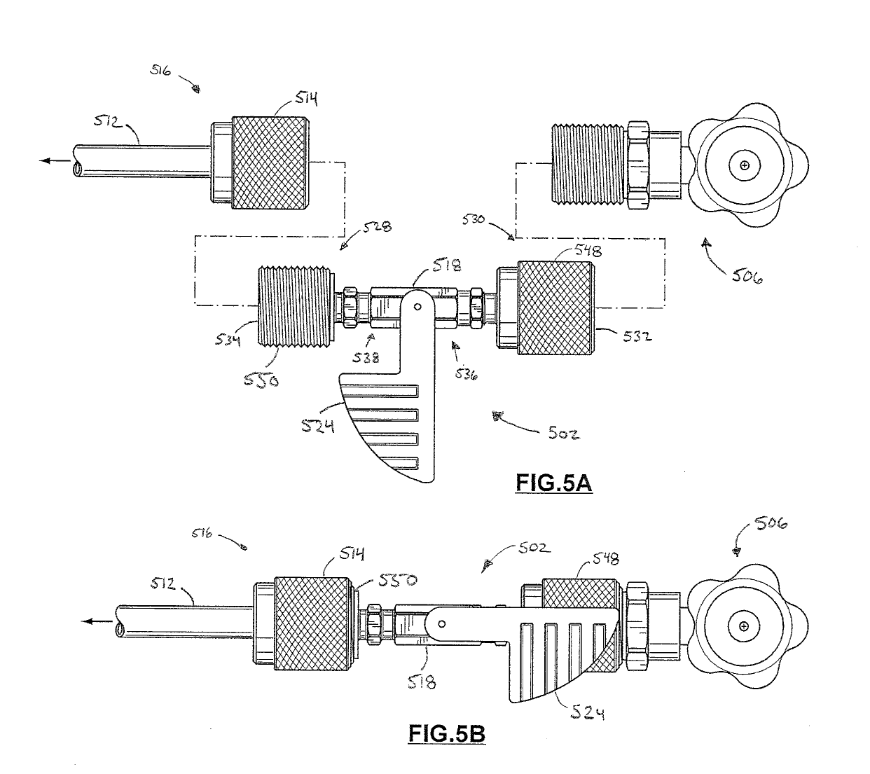

Reference is now made to FIGS. 5A and 5B. In yet a further embodiment, the safety valve apparatus 502 can be designed so that an existing supply conduit 512 comprising a coupler 514 can be retrofitted with the safety valve apparatus 502. For simplicity, the following paragraphs use reference numerals similar, differing by 200, to the reference numerals of the safety valve apparatus shown in FIGS. 3A and 3B, namely safety valve apparatus 302. However, a person skilled in the art will appreciate that these aspect of the present invention are not limited to retrofitting using safety valve apparatus 302 only and can include retrofitting using any of the embodiments for the safety valve apparatus described herein.

In some embodiments, retrofitting can involve attaching a safety valve apparatus 502 to the upstream end 516 of a supply conduit 512. The safety valve apparatus 502 can have an upstream opening 532, a downstream opening 534, and a shut-off valve 518 connected between the upstream opening 532 and the downstream opening 534. The shut-off valve 518 can have an upstream end 536 proximal the upstream opening 532 and a downstream end 538 proximal the downstream opening 534. The shut-off valve 518 can have a closed position and an open position. In the open position the shut-off valve 518 can provide a fluid flow pathway for the LPG from the upstream end 536 of the shut-off valve 518 to the downstream end 538 and in the closed position the shut-off valve 518 can block flow of fluid from the downstream end 538 to the upstream end 536 of the shut-off valve 518. Attaching the safety valve apparatus 502 to the upstream end 516 of the supply conduit 512 can comprise attaching the downstream opening 534 of the safety valve apparatus 502 to the coupler 514 at the upstream end 116 of a supply conduit 512. The safety valve apparatus 502 can have an upstream end 530 having the upstream opening 532. The upstream end 530 of the safety valve apparatus 502 can be configured to connect to an LPG container 506 (shown in part in FIGS. 5A and 5B).

In a further embodiment, the upstream end 516 of the supply conduit 512 can be attached to the safety valve apparatus 502 by threaded attachment. In other embodiments the upstream end 516 of the supply conduit 512 can be attached to the safety valve apparatus 502 by press fit, welding, or bonding. In other embodiments the upstream end 516 of the supply conduit 516 can be attached to the safety valve apparatus 502 through a variety of attachment methods known in the art in accordance with different embodiments of the present invention.

In further embodiments, attaching the downstream opening 534 of the safety valve apparatus 502 to the coupler 514 can involve a nozzle 550 positioned at a downstream end 528 of the safety valve apparatus 502. The nozzle 550 can have the downstream opening 534. The nozzle 550 can be a similar nozzle onto which the coupler 514 can attach.

In a further embodiment, the upstream end 530 of the safety valve apparatus 502 can be configured to connect to the LPG container 506 by providing the upstream end 530 of the safety valve apparatus 502 with a similar coupler 548 to the coupler 514. In some embodiments, the similar coupler 548 can be a quick-connect type coupler (or quick coupling), similar to those described above. It will be appreciated by a person skilled in the art that configuring the upstream end 530 of the safety valve apparatus 502 to connect to the LPG container 506 is not limited to the use of a similar coupler 548 to the coupler 514 or a quick-connect type coupler and can include for a variety of methods for attaching an

LPG container 506 to a supply conduit known in the art in accordance with different embodiments of the present invention.

In a further embodiment, the shut-off valve 518 can be located immediately downstream from the upstream opening 532 when the safety valve apparatus 502 is attached to the upstream end 516 of the supply conduit 512.

In a further embodiment, an internal volume of the safety valve apparatus 502 between the upstream opening 532 and the shut-off valve 518 can be less than 2 milliliters, to limit the amount of LPG containable within the internal volume of the safety valve apparatus 502 between the upstream opening 532 and the shut-off valve 518. In other embodiments, the internal volume of the safety valve apparatus 502 between the upstream opening 532 and the shut-off valve 518 can be less than 1.1 milliliters or 0.8 milliliters.

In a further embodiment, the shut-off valve 518 can comprise an external arm 524. The external arm 524 can be oriented in a manner similar to those mentioned previously that allows the external arm 524 to impede access to, or detachment of, the upstream end 530 of the safety valve apparatus 502 from the LPG container 506. The external arm 524 can be movable by an operator to switch the shut-off valve 518 between the open position and the closed position. The external arm 524 can be connected to the shut-off valve 518 such that when the shut-off valve 518 is in the closed position, the external arm 524 is in a closed arm position, and when the shut-off valve 518 is in the open position, the external arm 524 is in an open arm position. The external arm 524 can be moveable between the open arm position and the closed arm position. Attaching the safety valve apparatus 502 to the upstream end 516 of the supply conduit 512 can comprise orienting the external arm 524 relative to the upstream end 530 of the safety valve apparatus 502 such that the external arm 524 in the closed arm position does not impede disconnecting the upstream end 530 of the safety valve apparatus 502 from the LPG container 506, while the external arm 524 in the open arm position does impede disconnecting the upstream end 530 of the safety valve apparatus 502 from the LPG container 506.

In a further embodiment, orienting the external arm 524 relative to the upstream end 530 of the safety valve apparatus 502 can comprise orienting the external arm 524 such that the external arm 524 in the open arm position abuts the upstream end 530 of the safety valve apparatus 502 to impede disconnecting the upstream end 530 of the safety valve apparatus 502 from the LPG container 506.

In a further embodiment, the upstream end 530 of the safety valve apparatus 502 can have an external surface and can be disconnectable from the LPG container 506 by the external surface being gripped and rotated. Orienting the external arm 524 relative to the upstream end 530 of the safety valve apparatus 502 can comprise orienting the external arm 524 such that the external arm 524 in the open arm position abuts and impedes gripping of a substantial portion of the external surface of the upstream end 530 of the safety valve apparatus 502.

In a further embodiment, the upstream end 530 of the safety valve apparatus 502 can have an external surface and can be disconnectable from the LPG container 506 by the external surface being gripped and rotated through a path of rotation. Orienting the external arm 524 relative to the upstream end 530 of the safety valve apparatus 502 can comprise orienting the external arm 524 such that the external arm 524 in the open arm position protrudes into the path of rotation of the external surface of the upstream end 530 of the safety valve apparatus 502 to interfere with rotation of the external surface of the upstream end 530 of the safety valve apparatus 502 through the path of rotation.

In a further embodiment, the shut-off valve 518 can be a one-way valve configured to provide one-way fluid flow by moving to the open position to provide LPG flow from the upstream end 536 of the shut-off valve 518 to the downstream end 538 and by moving to the closed position to block LPG flow from downstream end 538 to the upstream end 536 of the shut-off valve 518.

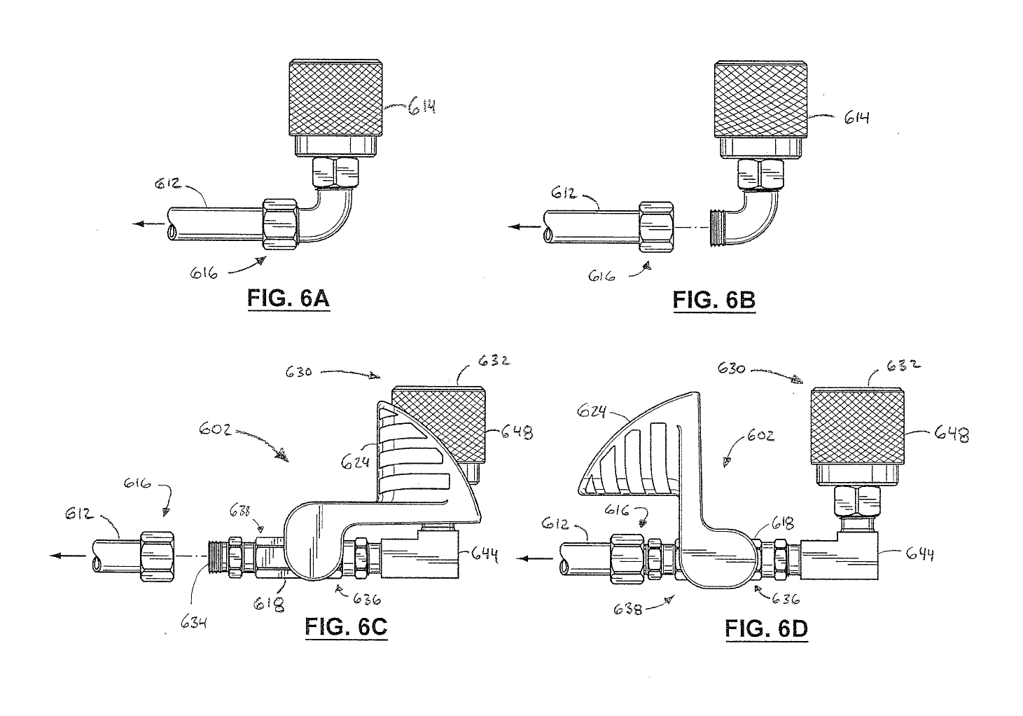

Reference is now made to FIGS. 6A to 6D. In yet a further embodiment, the safety valve apparatus 602 can be designed so that an existing supply conduit 612 comprising a coupler 614 can be retrofitted with the safety valve apparatus 602. For simplicity, the following paragraphs use reference numerals similar, differing by 400, to the reference numerals of the safety valve apparatus shown in FIGS. 2A to 2C, namely safety valve apparatus 202. However, a person skilled in the art will appreciate that these aspect of the present invention are not limited to retrofitting using safety valve apparatus 202 only and can include retrofitting using any of the embodiments for the safety valve apparatus described herein.

In some embodiments, retrofitting can involve attaching a safety valve apparatus 602 to the upstream end 616 of a supply conduit 612. The safety valve apparatus 602 can have an upstream opening 632, a downstream opening 634, and a shut-off valve 618 connected between the upstream opening 632 and the downstream opening 634. The shut-off valve 618 can have an upstream end 636 proximal the upstream opening 632 and a downstream end 638 proximal the downstream opening 634. The shut-off valve 618 can have a closed position and an open position. In the open position the shut-off valve 618 can provide a fluid flow pathway for the LPG from the upstream end 636 of the shut-off valve 618 to the downstream end 638 and in the closed position the shut-off valve 618 can block flow of fluid from the downstream end 638 to the upstream end 636 of the shut-off valve 618. Attaching the safety valve apparatus 602 to the upstream end 616 of the supply conduit 612 can comprise disconnecting the upstream end 616 of the supply conduit 612 from the coupler 614 and attaching the safety valve apparatus 602 to the upstream end 616 of the supply conduit 612 by attaching the downstream opening 634 to the upstream end 616 of the supply conduit 612. The safety valve apparatus 602 can comprise an upstream end 630 having the upstream opening 632. The upstream end 630 of the safety valve apparatus 602 can be configured to connect to an LPG container 606. In this embodiment, the coupler 614 can not be reused in the retrofitting process and can be discarded.

In a further embodiment, the upstream end 616 of the supply conduit 612 can be attached to the safety valve apparatus 602 by threaded attachment. In other embodiments the upstream end 616 of the supply conduit 612 can be attached to the safety valve apparatus 602 by press fit, welding, or bonding. In other embodiments the upstream end 616 of the supply conduit 616 can be attached to the safety valve apparatus 602 through a variety of attachment methods known in the art in accordance with different embodiments of the present invention.

In a further embodiment, the upstream end 630 of the safety valve apparatus 602 can be configured to connect to the LPG container 606 by providing the upstream end 630 of the safety valve apparatus 602 with a similar coupler 648 to the coupler 614. In some embodiments, the similar coupler 648 can be a quick-connect type coupler (or quick coupling), similar to those described above. It will be appreciated by a person skilled in the art that configuring the upstream end 630 of the safety valve apparatus 602 to connect to the LPG container 606 is not limited to the use of a similar coupler 648 to the coupler 614 or a quick-connect type coupler and can include for a variety of methods for attaching an LPG container 606 to a supply conduit known in the art in accordance with different embodiments of the present invention.

In a further embodiment, the safety valve apparatus 602 can include an elbow 644, similar to elbow 244 described above. In some embodiments the safety valve apparatus 602 can include a coupling 646, similar to coupling 346 described above.

In a further embodiment, the shut-off valve 618 can be located immediately downstream from the upstream opening 632 when the safety valve apparatus 602 is attached to the upstream end 616 of the supply conduit 612.

In a further embodiment, an internal volume of the safety valve apparatus 602 between the upstream opening 632 and the shut-off valve 618 can be less than 2 milliliters, to limit the amount of LPG containable within the internal volume of the safety valve apparatus 602 between the upstream opening 632 and the shut-off valve 618. In other embodiments, the internal volume of the safety valve apparatus 602 between the upstream opening 632 and the shut-off valve 618 can be less than 1.1 milliliters or 0.8 milliliters.

In a further embodiment, the shut-off valve 618 can comprise an external arm 624. The external arm 624 can be oriented in a manner similar to those mentioned previously that allows the external arm 624 to impede access to, or detachment of, the upstream end 630 of the safety valve apparatus 602 from the LPG container 606. The external arm 624 can be movable by an operator to switch the shut-off valve 618 between the open position and the closed position. The external arm 624 can be connected to the shut-off valve 618 such that when the shut-off valve 618 is in the closed position, the external arm 624 is in a closed arm position, and when the shut-off valve 618 is in the open position, the external arm 624 is in an open arm position. The external arm 624 can be moveable between the open arm position and the closed arm position. Attaching the safety valve apparatus 602 to the upstream end 616 of the supply conduit 612 can comprise orienting the external arm 624 relative to the upstream end 630 of the safety valve apparatus 602 such that the external arm 624 in the closed arm position can not impede disconnecting the upstream end 630 of the safety valve apparatus 602 from the LPG container 606, and the external arm 624 in the open arm position can impede disconnecting the upstream end 630 of the safety valve apparatus 602 from the LPG container 606.

In a further embodiment, orienting the external arm 624 relative to the upstream end 630 of the safety valve apparatus 602 can comprise orienting the external arm 624 such that the external arm 624 in the open arm position abuts the upstream end 630 of the safety valve apparatus 602 to impede disconnecting the upstream end 630 of the safety valve apparatus 602 from the LPG container 606.

In a further embodiment, the upstream end 630 of the safety valve apparatus 602 can have an external surface and can be disconnectable from the LPG container 606 by the external surface being gripped and rotated. Orienting the external arm 624 relative to the upstream end 630 of the safety valve apparatus 602 can comprise orienting the external arm 624 such that the external arm 624 in the open arm position abuts and impedes gripping of a substantial portion of the external surface of the upstream end 630 of the safety valve apparatus 602.

In a further embodiment, the upstream end 630 of the safety valve apparatus 602 can have an external surface and can be disconnectable from the LPG container 606 by the external surface being gripped and rotated through a path of rotation. Orienting the external arm 624 relative to the upstream end 630 of the safety valve apparatus 602 can comprise orienting the external arm 624 such that the external arm 624 in the open arm position protrudes into the path of rotation of the external surface of the upstream end 630 of the safety valve apparatus 602 to interfere with rotation of the external surface of the upstream end 630 of the safety valve apparatus 602 through the path of rotation.

In a further embodiment, the shut-off valve 618 can be a one-way valve configured to provide one-way fluid flow by moving to the open position to provide LPG flow from the upstream end 636 of the shut-off valve 618 to the downstream end 638 and by moving to the closed position to block LPG flow from downstream end 638 to the upstream end 636 of the shut-off valve 618.

While the above description provides examples of one or more methods or apparatuses, it will be appreciated by a person skilled in the art that other methods or apparatuses can be within the scope of the accompanying claims.

The invention claimed is:

1. A forklift truck comprising:
a truck frame for supporting a liquid petroleum gas (LPG) container;
an engine for powering the forklift truck, the engine being configured to run on LPG; and
a LPG supply system having
a supply conduit for supplying LPG from the LPG container to the engine,
a coupler for coupling to the LPG container, and
a shut-off valve installed in fluid communication with the supply conduit downstream from the coupler, the shut-off valve having a coupler end proximal the coupler and a conduit end proximal the supply conduit, the shut-off valve having a closed position and an open position wherein in the open position the shut-off valve provides a fluid flow pathway of the fluid from the coupler end to the conduit end, and in the closed position the shut-off valve blocks flow of the LPG from the conduit end to the coupler end.

2. The forklift truck as defined in claim 1 wherein the shut-off valve is installed in fluid communication with the supply conduit immediately downstream from the coupler.

3. The forklift truck as defined in claim 1 wherein an internal volume of an interior volume provided between the shut-off valve in the closed position and the coupler is less than 2 milliliters to limit an amount of LPG containable within the interior volume provided between the shut-off valve in the closed position and the coupler.

4. The forklift truck as defined in claim 1 wherein;
the shut-off valve comprises an external arm movable by an operator to switch the shut-off valve between the open position and the closed position;
the external arm is movable between an open arm position and a closed arm position;
the external arm is connected to the shut-off valve such that when the shut-off valve is in the closed position, the external arm is in the closed arm position and does not impede decoupling the coupler, and when the shut-off valve is in the open position, the external arm is in the open arm position and impedes decoupling the coupler.

5. The forklift truck as defined in claim 4 wherein the external arm in the open arm position abuts the coupler to impede decoupling the coupler.

6. The forklift truck as defined in claim 5 wherein the coupler has an external surface and is decouplable by the external surface being gripped and rotated, and the external arm in the open arm position abuts and impedes gripping of a substantial portion of the external surface of the coupler.

7. The forklift truck as defined in claim 4 wherein the coupler has an external surface and is decouplable by the external surface being gripped and rotated through a path of rotation, and the external arm in the open arm position protrudes into the path of rotation to interfere with rotation of the external surface of the coupler by blocking the path of rotation.

8. The forklift truck as defined in claim 1 wherein the shut-off valve is a one-way valve configured to provide one-way fluid flow by moving to the open position to provide LPG flow from the coupler end to the supply conduit end and by moving to the closed position to block LPG flow from the supply conduit end to the coupler end.

9. A method for modifying a forklift truck having a truck frame for supporting a liquid petroleum gas (LPG) container; an engine for powering the forklift, the engine being configured to run on LPG; a supply conduit for supplying LPG from the LPG container to the engine; and a coupler, having a first end configured for attachment to an upstream end of the supply conduit, to connect the supply conduit to the LPG container; the method comprising:
attaching a safety valve apparatus to the upstream end of the supply conduit, the safety valve apparatus having an upstream opening, a downstream opening, and a shut-off valve connected between the upstream opening and the downstream opening;
the shut-off valve having an upstream end proximal the upstream opening and a downstream end proximal the downstream opening, the shut-off valve having a closed position and an open position wherein in the open position the shut-off valve provides a fluid flow pathway of the fluid from the upstream end of the shut-off valve to the downstream end, and in the closed position the shut-off valve blocks flow of the fluid from the downstream end to the upstream end of the shut-off valve.

10. The method as defined in claim 9 wherein attaching the safety valve apparatus to the upstream end of the supply conduit comprises attaching the downstream opening of the safety valve apparatus to the coupler, the safety valve apparatus comprising an upstream end having the upstream opening, the upstream end of the safety valve apparatus being configured to connect to the LPG container.

11. The method as defined in claim 9 wherein attaching the safety valve apparatus to the upstream end of the supply conduit comprises disconnecting the coupler from the upstream end of the supply conduit; and then attaching the safety valve apparatus to both the coupler and the upstream end of the supply conduit by attaching the downstream opening to the upstream end of the supply conduit and the upstream opening to the first end of the coupler.

12. The method as defined in claim 9 wherein attaching the safety valve apparatus to the upstream end of the supply conduit comprises disconnecting the coupler from the upstream end of the supply conduit; and then attaching the safety valve apparatus to the upstream end of the supply conduit by attaching the downstream opening to the upstream end of the supply conduit, the safety valve apparatus comprising an upstream end having the upstream opening, the upstream end of the safety valve apparatus being configured to connect to the LPG container.

13. The method as defined in claim 12 wherein the shut-off valve is located immediately downstream from the upstream opening when the safety valve apparatus is attached to the upstream end of the supply conduit.

14. The method as defined in claim 12 wherein an internal volume of the safety valve apparatus between the shut-off valve and the upstream opening is less than 2 milliliters to limit an amount of LPG containable within the internal volume of the safety valve apparatus between the shut-off valve and the upstream opening.

15. The method as defined in claim 12 wherein;
the shut-off valve comprises an external arm movable by an operator to switch the shut-off valve between the open position and the closed position, the external arm being connected to the shut-off valve such that when the shut-off valve is in the closed position, the external arm is in a closed arm position, and when the shut-off valve is in the open position, the external arm is in an open arm position;
the external arm is movable between the open arm position and the closed arm position;
attaching the safety valve apparatus to the upstream end of the supply conduit comprises orienting the external arm relative to the upstream end of the safety valve apparatus such that the external arm in the closed arm position does not impede disconnecting the upstream end of the safety valve apparatus from the LPG container, and the external arm in the open arm position impedes disconnecting the upstream end of the safety valve apparatus from the LPG container.

16. The method as defined in claim 15 wherein orienting the external arm relative to the upstream end of the safety valve apparatus comprises orienting the external arm such that the external arm in the open arm position abuts the upstream end of the safety valve apparatus to impede disconnecting the upstream end of the safety valve apparatus from the LPG container.

17. The method as defined in claim 16 wherein;
the upstream end of the safety valve apparatus has an external surface and is disconnectable from the LPG container by the external surface being gripped and rotated; and
orienting the external arm relative to the upstream end of the safety valve apparatus comprises orienting the external arm such that the external arm in the open arm position abuts and impedes gripping of a substantial portion of the external surface of the upstream end of the safety valve apparatus.

18. The method as defined in claim 15 wherein;
the upstream end of the safety valve apparatus has an external surface and is disconnectable from the LPG container by the external surface being gripped and rotated through a path of rotation; and
orienting the external arm relative to the upstream end of the safety valve apparatus comprises orienting the external arm such that the external arm in the open arm position protrudes into the path of rotation to interfere with rotation of the external surface of the upstream end of the safety valve apparatus through the path of rotation.

19. The method as defined in claim 12 wherein;
the shut-off valve is a one-way valve configured to provide one-way fluid flow by moving to the open position to provide LPG flow from the upstream end of the shut-off valve to the downstream end and by moving to the closed position to block LPG flow from the downstream end to the upstream end of the shut-off valve.
